(19) United States
(12) Patent Application Publication
(10) Pub. No.: US 2006/0020583 A1
(43) Pub. Date: Jan. 26, 2006

(54) System and method for searching and retrieving documents by their descriptions

(76) Inventors: Alexey V. Baranov, Moscow (RU); Vasily Ishchenko, Moscow (RU); Alexandr V. Putilov, Moscow (RU)

Correspondence Address: Fay Kaplun & Marcin, LLP, Suite 702, 150 Broadway, New York, NY, 10038, US

(21) Appl. No.: 10/897,536

(22) Filed: Jul. 23, 2004

(51) Int. Cl. G06F 17/30

(52) U.S. Cl. 707/3

(57) ABSTRACT

Described is a method and system for searching and retrieving documents by their descriptions stored in databases and information resources with different document creation standards. The described method allows to decrease of the volume of the information displayed to the user terminal at a user's request and decrease of intellectual efforts necessary to analyze the information obtained and come to a decision. The practical result is being achieved owing to the fact that all the homogenous documents from different databases are sorted by separate folders, the rating of each document is determined within a folder, hereafter the coincidence number of the characteristics of certain documents is counted in the different folders and the final rating of each document is evaluated taking into account the overlapping number, and then the documents are sorted by this rating and sent to the user's computer.

### FIELD OF INVENTION

The present invention relates to a method and system for searching and retrieving documents by their descriptions stored in databases and information resources with different document creation standards.

### BACKGROUND INFORMATION

There are several known methods of retrieving documents by their descriptions. Known methods are typically based on a transforming of text in natural language in certain areas of knowledge into signals suitable for computer treatment, composing a request in the form of a key word selection, and comparing the key word selection of the request with the texts' thesauruses stored in a database (e.g., RU Utility Model No. 8819, RF Patent No. 2,107,942, U.S. Pat. No. 6,460,034, an information storage and retrieval system Yandex). A shortcoming of such known methods is their restriction to a single database with a fixed creation standard or structure.

For example, RU Patent No. 2,167,450 discloses a method of processing requests in an information search and retrieval system in which: 1) a set of objects is stored in a repository of documents, where each object of a document is defined by characteristics that are contained in the document, so that the objects stored in the document determine the general content of the said document; 2) a request, containing at least one request element for retrieval of at least one document relevant to at least the above mentioned request element, is then processed; 3) at least one document is identified from the set of objects; and 4) the identified document(s) is then represented to a user with the similarity of the documents being estimated with the help of ranking methods.

Another shortcoming of the known method is that it has no evaluation of objects, or characteristics, and documents by their significance relating to the given request element, i.e. the evaluation of their relevance. The equal probability of retrieving any of the selected objects and documents of varying relevances results in an increase of the volume of selected information. Sorting through irrelevant information in the final analysis increases intellectual efforts of a user for handling the selected information.

Moreover, in the case of dealing with more than one repository or database of documents with different document creation standards or structures, the identification of the objects becomes difficult to accomplish.

### SUMMARY OF THE INVENTION

The system and method disclosed herein includes composing of at least one retrieval request by a user at a work station, sending the request composed by the user to a retrieval system, and processing by the retrieval system the requests composed by the user resulting in retrieval of documents from a database. The system and method additionally includes the following operations: the system sorts retrieved documents by their subjects and creates folders, each of which contains the sorted documents with the same subject; for each sorted document, characteristics are determined that specify this document; within each folder the retrieval system determines the rating of each characteristic of each sorted document; hereafter the retrieval system counts the number of the characteristics of the certain sorted documents in one folder that coincide with the characteristics of the other documents in the other folders; then it calculates the final rating of each sorted document taking into account the coincidence number of characteristics and weighting factor of a database; the system then sorts the documents again in accordance with their final document rating and then sends the sorted by the final rating documents to the user's terminal.

In an exemplary embodiment according to the present invention, the final rating of the (i-th) sorted document is calculated by the formula:

$${R}_{i} = {\sum }_{\begin{matrix}j = 1 \\ {x}_{i , j} = 0\end{matrix}}^{n} {a}_{j} \frac{1}{{x}_{i , j}} + {l}_{i} + {c}_{i} , i = 1 , m$$

where,
   x_{i,j} is a rating of the i-th document in the j-th database;
   aⱼ is a rating of the j-th database;
   lᵢ is a quantity of not equal to zero ratings of the i-th document in all databases; and
   cᵢ is a coincidence number of the different characteristics of certain documents in different folders.

### BRIEF DESCRIPTION OF DRAWINGS

FIG. 1 shows a system for searching and retrieving documents according to the present invention.

FIG. 2 shows a method for searching and retrieving documents according to the present invention.

### DETAILED DESCRIPTION

The present invention is directed to a system and method for searching and retrieving documents by their descriptions. The practical result of the claimed invention is a decrease in the volume of information displayed to a user's terminal from a user's request and a decrease of intellectual efforts necessary to analyze the information obtained and come to a decision.

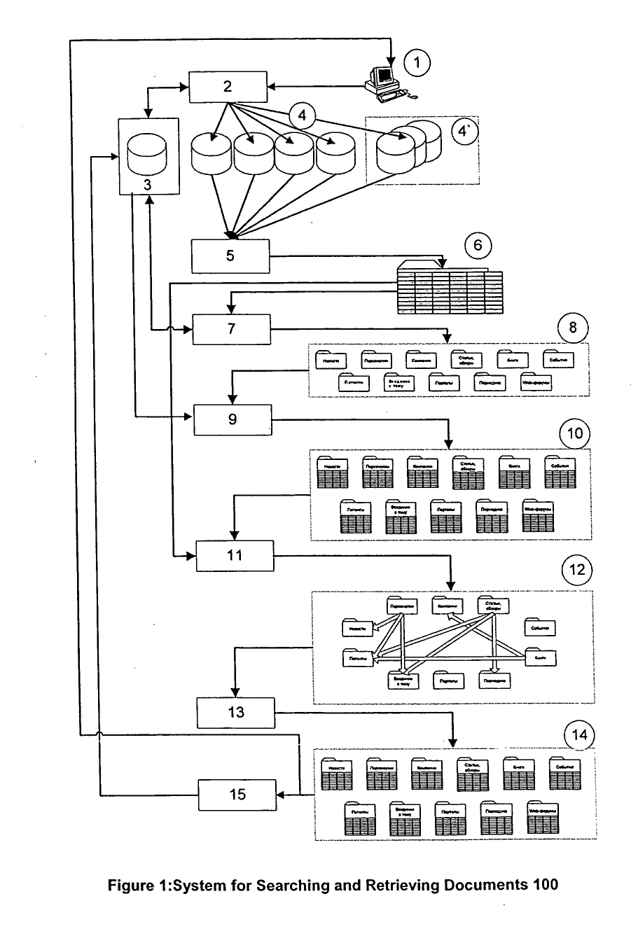

FIG. 1 shows a system for searching and retrieving documents 100 according to the present invention. The retrieval system 100 includes a terminal 1. The terminal 1 may include a computer (e.g., an IBM compatible personal computer). The terminal 1 may also include a computer display or monitor, a keyboard, and a mouse.

The retrieval system 100 may include a request transformer 2 in communication with the terminal 1. The request transformer 2 may include, for example, a 32-bit computer (e.g. Linux, Solaris, FreeBSD, Win32). In an exemplary embodiment of the retrieval system 100 according to the present invention, the request transformer 2 may receive and process a user's request using a search program. The search program may include, for example, Fast software available from the Norwegian company “Fast Search & Transfer ASA.” Fast utilizes direct search logic to receive and process a user's request.

Shown in FIG. 1, the retrieval system 100 may include a standards database 3 and a information resources database 4. The request transformer 2 may be in communication with the standards database 3 and the information resources database 4. As one of ordinary skill in the art would understand, the standards database 3 and the information resources database 4 may be remote databases or a local databases. Communication, or access, to the databases from the terminal 1 may be achieved via a connection from terminal 1 to a net (e.g. the Internet, or a local net, for example, an Intranet).

In an exemplary embodiment of the retrieval system 100 according to the present invention, the standards database 3 is stored in the memory of the retrieval system 100. The standards database 3 may be, for example, stored on a hard disk memory in the terminal 1.

The information resources database 4 may include at least one sub-database, information resources database 4′. The information resources databases 4′ may be co-located, or each may exist in separate locations, either remote or local to the retrieval system 100. In an exemplary embodiment according to the present invention, the information resources databases 4′ may be homogenous, wherein each sub-database contains documents with the same subject (e.g., a patent database). In another exemplary embodiment according to the present invention, the information resources databases 4′ may be heterogeneous, wherein each sub-database contains documents with different subjects (e.g., Yandex).

The retrieving system 100 according to the present invention may be used to search and retrieve information or documents from the information resources databases 4,4′. For example, a user may compose and enter a request via the terminal 1. The request may be, for example, a document search request represented as a keyword, or a keyword set. For example, a keyword set may be “Environmental monitoring”. However, the request may be of any request structure (e.g., keyword, keyword set, Internet address, Structured Query Language) known to those of ordinary skill in the art. The request structure may correspond to one information resources database 4,4′, or multiple information resources databases 4,4′.

The request may be received by the request transformer 2. In an exemplary embodiment of the retrieval system 100 according to the present invention, the request transformer 2 receives and processes the request using the search program.

Upon receipt of a request, the request transformer 2 may search the standards database 3 for data relevant to the request. The standards database 3 may contain information about the request structure. For example, the standards database 3 may include addresses of information resource databases 4,4′ (e.g. Internet search engines and information databases) that correspond to the particular request structure. The standards database 3 may also include database ratings of relevant information resource databases 4,4′. The database ratings may be based on the number of relevant documents identified in a particular information resource database 4′ by prior requests to the retrieval system 100.

The retrieval system 100 according to the present invention may be used, for example, to search and retrieve documents from a database of U.S. patents. The format of a request to a information resource database 4′ at the USPTO of U.S. patents via the Internet may be of the following structure:
“http://patft.uspto.gov/netacgi/nph-Parser?Sect1=PTO2&Sect2=HITOFF&p=1&u=%2Fnetahtml%2Fsearch-bool.html&r=0&f=S&l=50& TERM1=“keyword“&FIELD1=&co1=AND&TERM2=&FIELD2=&d=ptxt”

In another exemplary embodiment of the retrieval system 100 according to the present invention, Structured Query Language (“SQL”) may be used in a request. An exemplary SQL request via a local net to a local, corporate or other information resources database 4 (e.g. a database stored on a hard disk or on CD-ROM) may be of the following structure:
“DECLARE @FIELD1 VARCHAR(100),@FIELD2 VARCHAR(100),@FIELD3 VARCHAR(100)
SET @FIELD1=‘%’
SET @FIELD2=‘%’
SET @FIELD3=‘%’
SELECT*FROM <TABLE_NAME>
WHERE <FIELD1> LIKE @FIELD1
AND <FIELD2> LIKE @FIELD2
AND <FIELD3> LIKE @FIELD3”

Upon receiving a user's request, the request transformer 2 may compose secondary requests to supplement the user's request. Secondary requests may be composed based on the request structure data and information resources database data stored in the standards database 3. Secondary requests may be useful, for example, to broaden the user's search and retrieve documents from additional information resources databases 4,4′. The secondary requests may have different structures than the user's request to correspond to different information resources databases 4,4′. In an exemplary embodiment according to the present invention, secondary requests may be sent to relevant information resources databases 4,4′ according to their database ratings in descending order. In the above exemplary request to the USPTO patent database, the request transformer 2 may, for example, compose a secondary request to a relevant information resources database 4,4′, such as the joint Computerized Engineering Index and EI Engineering Meetings database (“COMPENDEX”).

In another example, a user's request entered in the terminal 1 may include a keyword “garbage.” The request transformer may compose secondary requests with different request structures. For example, the secondary requests may look like the following:

To the USPTO patent database:

“http://patft.uspto.gov/netacgi/nph-Parser?Sect1=PTO2&Sect2=HITOFF&p=1&u=%2Fnetahtml%2Fsearch-bool.html&r=0&f=S&l=50&TER M1=“garbage”&FIELD1=&co1=AND&TERM2=&FIELD2=&d=ptxt”;
   To the “COMPENDEX” database:
”DECLARE @FIELD1 VARCHAR(100),@FIELD2 VARCHAR(100),@FIELD3 VARCHAR(100)
SET @FIELD1=‘GARBAGE’
SET @FIELD2=‘GARBAGE’
SET @FIELD3=‘GARBAGE’
SELECT*FROM COMPENDEX
WHERE TITLE LIKE @FIELD1
AND CONFERENCE TITLE LIKE @FIELD2
AND ABSTRACT LIKE @FIELD3″

Shown in FIG. 1, the retrieval system 100 may include a document integrator 5. The document integrator 5 may include, for example, a 32-bit computer (e.g. Linux, Solaris, FreeBSD, Win32). The document integrator 5 may be in communication with the information resources databases 4,4′.

Each document identified in an information resources database 4,4′ by a request may include a corresponding document record or description. The document record may include, for example, a title, an abstract, an author or authors, a summary, a document type, an e-mail address, and any other data as it is defined in information resources standards. The document records and corresponding documents retrieved from information resources databases 4,4′ may be accumulated in the document integrator 5.

For example, document records retrieved from the information resources databases 4,4′ may look like the following:

From the USPTO patent database:

Inventors: Lieberman; Noah (Boulder, Colo.)
Assignee: Sun Microsystems, Inc. (Santa Clara, Calif.)
Appl No: 39101
Current U.S. Class: 709/225; 709/229; 709/2
Intern'l Class: G06F 015/173; G06F 015/16
Abstract: A content provider manager has been develop for use in an information services such as a portal or desktop application to provide for “pluggable” content that may be modified simply through . . .
   From the COMPENDEX database:
DIALOG No: 04265680 EI Monthly No: EIP95102889590
Title: Cache performance of fast-allocating programs
Author: Goncalves, Marcelo J. R.; Appel, Andrew W.
Corporate Source: Princeton Univ
Conference Title: Conference Record of Conference on Functional Programming
Languages and Computer Architecture
Conference Location: La Jolla, Calif., USA
Conference Sponsor: ACM SIGPLAN; ACM SIGARCH; IFIP
Source: Conf Rec Conf Funct Program Lang Comput Archit 1995. ACM. p 293-305
Publication Year: 1995
Language: English
Conference Number: 43744
Document Type: CA; (Conference Article) Treatment Code: X; (Experimental)
Abstract: We study the cache performance of a set of ML programs, compiled by the Standard ML of New Jersey compiler. We find that more than half of the reads are for objects that have just been allocated . . .

Descriptors: *Program compilers; Buffer storage; Storage allocation (computer); Computer software; Computer hardware; Performance; Computer architecture
Identifiers: Cache performance; New Jersey compiler; Garbage collection frequency; Runtime systems”

The document integrator 5 may integrate the documents to correspond to the document records, into a unified array. The unified array may be stored in a unified repository database 6. In an exemplary embodiment according to the present invention, the structure of each document is kept unchanged in the unified repository database 6. The unified repository database 6 may be stored in the memory of the retrieval system 100. For example, the unified repository database 6 may be stored on a hard disk memory in the terminal 1.

The unified repository database 6, including the the retrieved documents, may possess a redundancy of documents. For example, it is possible that the same document may be retrieved from different information resources databases 4′ and be represented in the unified repository database 6 more than once.

The retrieval system 100 according to the present invention may include a document sorter 7, shown in FIG. 1. The document sorter 7 may be in communication with the unified repository database 6 and the standards database 3. The document sorter 7 may include, for example, a 32-bit computer (e.g. Linux, Solaris, FreeBSD, Win32). The unified array of documents retrieved in a request may be transferred from the unified repository database 6 to a document sorter 7. The document sorter 7 may sort the retrieved documents based on data contained in the standards database 3. For example, the document sorter 7 may sort the retrieved documents by subject matter.

As shown in FIG. 1, the retrieval system 100 may also include a folder database 8. The folder database 8 may be in communication with the the document sorter 7. The folder database 8 may be stored in the memory of the retrieval system 100. For example, the folder database 8 may be stored on a hard disk memory in the terminal 1. The folder database 8 may include at least one folder. The folders may be created in accordance with the sort criteria of document sorter 7. In an exemplary embodiment according to the present invention, the folders are created to correspond to subject matter relevant to the user's request. The sorted documents in the document sorter 7 may be deposited in corresponding folders in the folder database 8.

In an exemplary embodiment of the retrieval system 100 according to the present invention, the folder database 8 includes multiple folders, each corresponding to a different single subject matter. In another exemplary embodiment according to the present invention, each folder may correspond to a real characteristic of a knowledge domain (e.g., author, organization, event, news, article, book etc).

The retrieval system 100 according to the present invention may include a characteristic processor 9, shown in FIG. 1. The characteristic processor 9 may include, for example, a 32-bit computer (e.g. Linux, Solaris, FreeBSD, Win32). The characteristic processor 9 may be in communication with the folder database 8 and the standards database 3. Documents from each folder in the folder database 8 may be processed by the characteristic processor 9. The characteristic processor 9 may create and sort lists of characteristics, or objects, of a document, based on a determined characteristic rating of a characteristic or object.

For example, documents stored in a folders of the folder database 8 may be transmitted to the characteristic processor 9. Simultaneously, information about the document's structure may be transmitted to the characteristic processor 9 from the standards database 3. Information from the standards database 3 may be compared with the information from the characteristic processor 9. As a result, information about the characteristics of the document are determined. These characteristics may include, for example: the title of the document, addresses of the documents connected with the characteristic, and statistical information about index numbers of the addresses of the documents in the lists of search information resources.

After complete processing of documents in a single folder, a characteristic rating of each characteristic may be determined. For example, the number of occurrences of a particular characteristic (e.g. an Author's name) in the documents of one folder may be tabulated. An example of characteristic ratings within a single folder is shown in Table 1.

TABLE 1
Example of Author's Rating

| | | Database (retrieving system) | | | | | | |
|---|---|---|---|---|---|---|---|---|
| No. | Author | Altavista | Yahoo | Amazon | Dialog | Patent | SCI | Total Rating |
| 1 | L. Cotton | 7 | 4 | 9 | — | 7 | 3 | 30 |
| 2 | D. Sillivane | 2 | — | — | 12 | 34 | 12 | 60 |
| 3 | K. Deburg | 11 | 12 | 14 | 33 | 1 | 1 | 72 |
| 4 | J. Smith | 12 | 6 | 44 | 2 | 10 | 2 | 76 |
| 5 | K. Moore | 23 | 17 | 11 | 29 | 5 | 12 | 97 |
| . | . | . | . | . | . | . | . | . |
| . | . | . | . | . | . | . | . | . |
| . | . | . | . | . | . | . | . | . |
| 154 | D. Dennie | 125 | 123 | 2 | — | 22 | 12 | 284 |

The lists of the characteristics and their attributes (e.g. characteristic rating) may be stored in a characteristics database 10. The characteristics database 10 may be stored in the memory of the retrieval system 100. For example, the characteristics database 10 may be stored on a hard disk memory in the terminal 1. After the characteristic processor 9 finishes processing one folder, it may process a next folder from the folder database 8. The characteristic processor 9 may continue to process folders from the folder database 8 until all folders have been processed.

The retrieval system 100 according to the present invention may include a reconstruction processor 11. The reconstruction processor 11 may be in communication with the characteristic database 10 and the unified repository database 6. The reconstruction processor 11 may include, for example, a 32-bit computer (e.g. Linux, Solaris, FreeBSD, Win32). The reconstruction processor 11 may receive the lists of the characteristics from the characteristic database 10 and attach to the characteristics the corresponding documents stored in the unified repository database 6. In an exemplary embodiment according to the present invention, the reconstruction processor 11 may perform a preliminary evaluation of relevance for each document originally selected in the document integrator 5. A preliminary document rating may be determined for each document based on the preliminary evaluation of relevance.

As shown in FIG. 1, the retrieval system 100 according to the present invention may include an overlapping number evaluator 12. The overlapping number evaluator 12 may be in communication with the characteristic transmitter 11. The overlapping number evaluator 12 may include, for example, a 32-bit computer (e.g., Linux, Solaris, FreeBSD, Win32). The overlapping number evaluator 12 may analyze existing overlappings among certain folders. For example, documents written by two authors, L. Cotton and J. Smith, may be retrieved using the retrieval system 100 according to the present invention. Shown in Table 2 for the purposes of this example, the documents by each author both refer to proceedings of a same conference, the International Conference of Building Officials. The conference is itemized in a conference list, shown in No. 4 of Table 3. The overlapping number evaluator 12 may determine a total number of overlappings for each characteristic. The number of overlappings may be used by system 100 when calculating a rating for each characteristic. In one exemplary embodiment of the retrieval system 100 according to the present invention, the number of overlappings may also be used to calculate a final document rating for each document.

TABLE 2
The List of the Conferences Authors Refer To

| No. | Author | Conference |
|---|---|---|
| 1 | L. Cotton | Intl. Conference of Building Officials |
| 2 | D. Sillivane | The United Nation Conference on Trade and |
| | | Develop. |
| 3 | K. Deburg | The Appalachian Trail Conference |
| 4 | J. Smith | Intl. Conference of Building Officials |
| 5 | D. Dennie | The US Conference of Mayors |

TABLE 3
The List of Conferences

| No. | Conference |
|---|---|
| 1 | Intl. Conference of Building Official |
| 2 | The United Nation Conference on Trade and Develop. |
| 3 | The Appalachian Trail Conference |
| 4 | House Republican Conference |
| 5 | The US Conference of Mayors |
| 6 | JavaOne SM Conference |

The retrieval system 100 according to the present invention may include a rating calculator 13. The rating calculator 13 may be in communication with the overlapping number evaluator 12. The rating calculator 13 may include, for example, a 32-bit computer (e.g. Linux, Solaris, FreeBSD, Win32). The rating calculator may determine a final document rating based on factors including a number of characteristics within the document and the database rating of the information resources database 4,4′from which the document was retrieved. The rating calculator 13 may calculate a final document rating of each document using the following formula:

$${R}_{i} = {\sum }_{\begin{matrix}j = 1 \\ {x}_{ij} \neq 0\end{matrix}}^{n} {a}_{j} \frac{1}{{x}_{ij}} + {l}_{i} + {c}_{i} , i = \overline{1 , m}$$

where,
   X_{i, j} is a document rating of the i-th document in the j-th database;
   aⱼ is a database rating of the j-th database;
   lᵢ is a number of the document ratings of the i-th document not equal to zero from all databases; and
   cᵢ is a number of the coincidence of the different characteristics of the certain documents in different folders.

The database rating aⱼ of the j-th database varies between 0,1 and 1,0.

In another exemplary embodiment according to the present invention, the number of overlappings may also be used by the ratings calculator to determine the final document ratings.

The retrieving system 100 may include a results database 14 in communication with the rating calculator 13. The retrieval system 100 may sort the documents by the final document ratings and store the documents in the results database 14. Sorted documents may be transferred from the results database 14 to the user at the terminal 1. For example, the sorted documents may be displayed on the computer display of the terminal 1 or may be stored in the memory of the terminal 1.

Shown in FIG. 1, the retrieval system 100 may also include a database rating calculator 15. The database rating calculator 15 may be in communication with the results database 14 and the standards database 3. The database rating calculator 15 may include, for example, a 32-bit computer (e.g. Linux, Solaris, FreeBSD, Win32). Databases accessed for a request may be rated by the database rating calculator 15 on the basis of the information stored in the results database 14. For example, the database rating of a particular database may be higher when more documents with high final document ratings or relevance were retrieved from the database. The database ratings may be transmitted to the standards database 3 and stored in the standards database 3. The database ratings may be used by the retrieval system 100 to improve efficiency for future user requests. The database rating calculator 15 may include a benchmark test to aid in evaluating the database ratings. The benchmark test may be based on measuring the time of reply. For example, more time of reply may correspond to a lower database rating.

In an exemplary embodiment according to the present invention, authors, organizations, news, events, scientific and technical literature, and patent documentation may be used as the characteristics or objects of the documents.

In another exemplary embodiment according to the present invention, articles in bulletins, monographs, collections of works, proceedings of conferences and other scientific meetings are treated as the different kinds of scientific and technical literature.

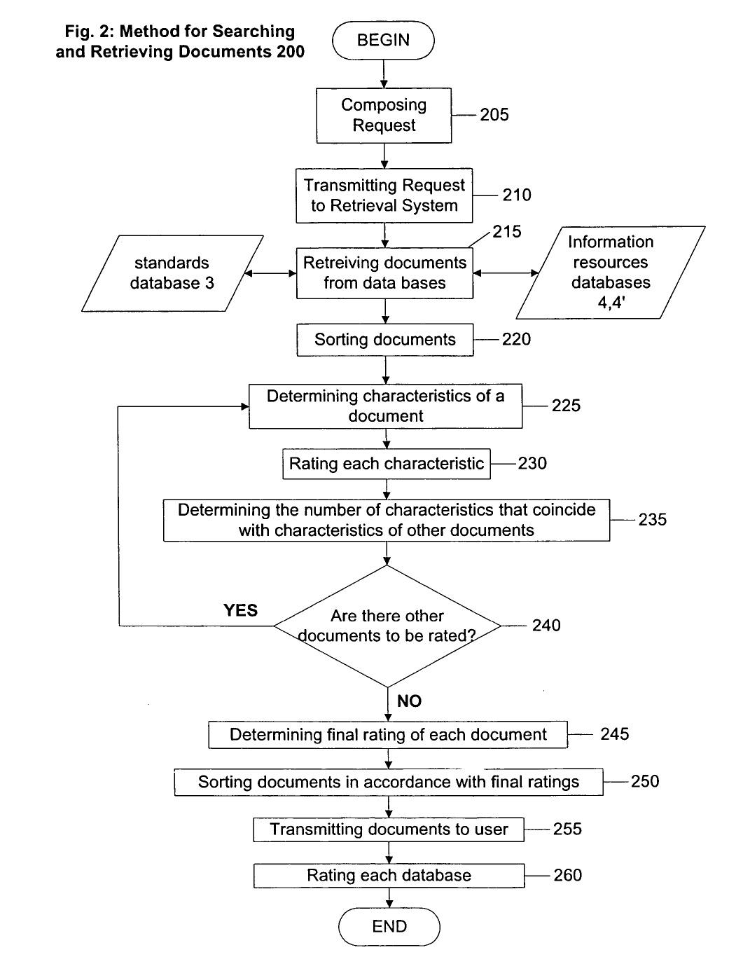

FIG. 2 shows a method for searching and retrieving documents 200 according to the present invention. The retrieval method 200 includes a first step 205 of composing at least one request by a user. The request may include a key word or a key word set. The retrieval method 200 includes a second step 210 of transmitting the request composed in step 205 to the retrieval system.

An additional step 215 includes processing the retrieval requests composed by the user by the retrieval system resulting in the retrieval of documents from databases. The databases may include information resources databases or any databases known to those of ordinary skill in the art.

A step 220 of the retrieval method 20 includes sorting the retrieved documents and storing them in folders. The folders may contain documents that correspond to a single subject. The retrieval method 200 according to the present invention may include a step 225 of determining characteristics of a retrieved document. The characteristics that specify the document are determined.

In a step 230, a characteristic rating may be determining of each characteristic identified within the retrieved document. In a step 235 of the retrieval method 200, the number of characteristics of the document that coincide with characteristics of other documents from other folders may be determined. In a step 240, steps 225-235 of the retrieval method may be repeated for each document retrieved by the user within each folder.

In a step 245, a final document rating of each document may be determined. In an exemplary embodiment of the retrieval method 200 according to the present invention, the final rating of each document may be determined using the following formula:

$${R}_{i} = {\sum }_{\begin{matrix}j = 1 \\ {x}_{ij} \neq 0\end{matrix}}^{n} {a}_{j} \frac{1}{{x}_{ij}} + {l}_{i} + {c}_{i} , i = \overline{1 , m}$$

where,
   x_{i,j} is a database rating of the i-th document in the j-th database;
   aⱼ is a database rating of the j-th database;
   lᵢ is a number of the ratings of the i-th document not equal to zero from all databases; and
   cᵢ is a number of the coincidence of the different characteristics of the certain documents in different folders.

The database rating aⱼ of the j-th database varies between 0,1 and 1,0.

In a step 250, the documents may be sorted in accordance with the final document ratings. The step 250 may be repeated one or more additional times. In a step 255, the sorted documents are transmitted to the user.

The retrieval method 200 may also include a step 260 of rating databases. A database rating may be determined for each database from which documents were retrieved. The database rating may be based on the number of documents retrieved from the database and the final document rating of the retrieved documents. The database ratings may be saved for use in later searching and retrieving of documents according to the present invention.

The system and method according to the present invention may decrease computing time needed to complete a search, increase relevance of the retrieved documents, and reduce intellectual efforts when analyzing the retrieved documents.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A method for searching and retrieving information, comprising the steps of:
receiving and processing by a retrieval system a user request for retrieval of documents from at least one database;
sorting by the retrieval system of the retrieved documents based on subjects thereof;
creating a folder for each subject of the retrieval documents, each of the folders containing the sorted documents with the same subject;
storing each of the retrieval documents in a corresponding one of the folders for the respective subject;
determining document specifying characteristics of each of the sorted documents;
within each folder, determining a characteristic rating of each characteristic of each document stored therein;
determining a number of characteristics of each of the stored documents in a selected one of the folders that coincide with characteristics of the documents stored in the other folders;
determining a preliminary document rating using the characteristic rating of the document specifying characteristics of each sorted document;
calculating a final document rating of each of the sorted documents using the determined number of coinciding characteristics and a weighting factor of the database;
sorting the documents in accordance with the final document ratings; and
sending documents, sorted by the final document ratings, to the user.

2. The method according to claim 1, further comprising the steps of:
calculating a database rating for each database; and
storing the database ratings in the retrieval system.

3. The method according to claim 2, wherein the final document rating of the sorted (i-th) document is calculated according to the following formula:
$${R}_{i} = {\sum }_{\begin{matrix}j = 1 \\ {x}_{ij} \neq 0\end{matrix}}^{n} {a}_{j} \frac{1}{{x}_{ij}} + {l}_{i} + {c}_{i} , i = \overline{1 , m}$$
where x_{i,j} is a preliminary document rating of the i-th document in the j-th database;
aᵢ is a database rating of the j-th database;
lᵢ is a quantity of not equal to zero document ratings of the i-th document in all databases; and
cᵢ is a coincidence number of the different characteristics of certain documents in different folders.

4. The method according to claim 3, wherein the database rating of the j-th database is between 0.1 and 1.0.

5. The method according to claim 1, wherein the characteristics of the documents include authors, organizations, news, events, types of scientific and technical literature and patent documentation identified in the documents.

6. The method according to claim 5, wherein articles in bulletins, monographs, collections of works, proceedings of conferences and other scientific meetings are treated as different kinds of scientific and technical literature.

7. The method according to claim 2, wherein the database rating is determined based on a benchmark test.

8. A system for searching and retrieving information, comprising:
a request transmitter receiving and processing a user request for retrieval of documents from an information database;
a standards database in communication with the request transmitter, to provide data to aid in the processing of the user request;
a document integrator collecting the retrieved documents and storing the retrieved documents in a unified repository database;
a document sorter sorting the retrieved documents based on the subjects thereof and storing the retrieved documents in folders corresponding to the subjects in a folders database;
a characteristics processor determining document specifying characteristics, storing the characteristics in a characteristics database, and determining a characteristic rating of each document characteristic;
a reconstruction processor determining a number of characteristics of each of the documents in a selected one of the folders that coincide with characteristics of the documents stored in the other folders;
a rating calculator calculating a final document rating of each of the retrieved documents using the determined number of coinciding characteristics and a weighing factor of the information database and sorting the documents in a results database according to the final document ratings.

9. The system according to claim 8,
wherein the information database includes a plurality of databases.

10. The system according to claim 9, wherein a database rating is calculated for each of the plurality of databases.

11. The system according to claim 8,
wherein the rating calculator determines a final document rating of a (i-th) document according to the following formula:
$${R}_{i} = {\sum }_{\begin{matrix}j = 1 \\ {x}_{ij} \neq 0\end{matrix}}^{n} {a}_{j} \frac{1}{{x}_{ij}} + {l}_{i} + {c}_{i} , i = \overline{1 , m}$$
where x_{i,j} is a preliminary document rating of the i-th document in the j-th database;
aⱼ is a database rating of the j-th database;
lᵢ is a quantity of not equal to zero document ratings of the i-th document in all databases; and
cᵢ is a coincidence number of the different characteristics of certain documents in different folders.
